(19) United States
(12) Patent Application Publication
(10) Pub. No.: US 2020/0258158 A1
(43) Pub. Date: Aug. 13, 2020

(54) SYSTEM AND METHOD FOR PROVIDING VIRTUAL SOCIAL BANKING NETWORKS BY A PLATFORM UTILIZING ARTIFICIAL INTELLIGENCE AND BLOCKCHAIN TECHNOLOGY

(71) Applicant: Sou Sou Investment Solutions, LLC, Washington, DC (US)

(72) Inventors: Fonta Gilliam, Washington, DC (US); Ramsey L. Smith, Washington, DC (US)

(21) Appl. No.: 16/785,055

(22) Filed: Feb. 7, 2020

Related U.S. Application Data
(60) Provisional application No. 62/802,581, filed on Feb. 7, 2019.

(51) Int. Cl. G06Q 40/06; G06Q 50/00; G06Q 40/02; G06Q 20/10; G06Q 30/00; G06Q 10/10; H04L 29/06; G06N 20/00

(52) U.S. Cl. CPC G06Q 40/06; G06Q 50/01; G06Q 40/025; G06Q 20/108; G06Q 2220/00; G06Q 10/10; H04L 63/08; G06N 20/00; G06Q 30/018

(57) ABSTRACT

A system and method for providing a virtual social banking platform, where the system creates and powers social banking networks made up of participants saving, investing, borrowing, and lending money through a computerized platform. A social savings network allows users to use social networking and social communications to monitor and encourage other participants to meet their savings goals, while a lending circle network allows participants to periodically contribute funds to a network reserve account, and, in rotation, individually access at least a portion of the funds in the network reserve account as funds for a loan, investment, or other payout option. AI and machine learning allows the system to track the spending and saving habits of users to offer incentives for meeting financial goals and to connect users with external financial institutions and products.

### CROSS REFERENCE TO RELATED APPLICATIONS

This application claims benefit of U.S. Provisional Patent Application No. 62/802,581, filed on Feb. 7, 2019, and entitled “A System and Method for Maintaining and Regulating Interest Accruing and Credit Building Networks by a Platform Utilizing Artificial Intelligence and Blockchain Technology.” Such application is incorporated by reference herein in its entirety.

### STATEMENT REGARDING FEDERALLY SPONSORED RESEARCH OR DEVELOPMENT

Not applicable.

### BACKGROUND OF THE INVENTION

Rotating Savings and Credit Associations (ROSCAs), one subcategory of social banking, are partnerships formed by a group of participants who make regular contributions to a fund, which is given to each participant in turn until each participant has received the fund (in some places, such as West Africa, these types of partnerships are referred to as a “su su” or “sou sou”). Contributions may be made to the fund on any designated time schedule (weekly, bi-weekly, monthly, etc.), allowing for participants to receive a lump-sum payment at a future date. This type of arrangement allows people who would not traditionally have access to loans or other substantial capital to have periodic access to these types of funds, which can allow otherwise money-burdened individuals to make investments, purchase goods, or otherwise engage in financial transactions. For this reason, ROSCAs and other informal savings and loan clubs are popular in developing countries in Asia, Africa, and South America.

While financial institutions and mainstream saving methods have excelled during the tech boom (many financial institutions have even begun to brand themselves as technology companies due to the tech-driven nature of financial transactions in today's society), the traditional social banking transition to the technology world has been dampened by the traditional savings mechanism's heavy dependence on its community-based, peer-accountability and trust-driven characteristics. That is, because these informal savings and loan club members may feel less incentive to commit to their future contributions once they have already received their lump-sum payment, most traditional social banking clubs occur informally amongst groups of individuals with strong communal ties and who have a strong social and economic reputation (giving peace of mind to all members of the social banking club). Furthermore, in addition to determining whether certain persons are ripe for participants in the social banking club, there are many other factors that must be considered before forming a social banking account—how much will be contributed and on what time scale, what will be the order of participants to receive the periodic lump sum, will the social banking account continue for many iterations or will it last only until each participant has received one lump-sum payment—making the creation of traditional social banking accounts cumbersome. This burden is only exacerbated during the formation of virtual social banking accounts, where a lack of appropriate credit risk scores and a lack of quantitative reasoning hinders the formation of the partnership and makes automated, traditional social banking accounts too problematic to create and join in virtual networks.

In addition to challenges with providing virtual social banking accounts, mainstream financial institutions are having increasingly more difficulty attracting new customers in today's technological environment. These mainstream financial institutions traditionally have limited options when attracting new customers: they can open new branches, devise a marketing campaign, deploy a sales team, or host community events. However, these options do not come without their own problems. Opening new branches is costly, labor intensive and does not attract the millennial consumer. A marketing and public relations campaign does little for the retention of customers. Deployment of a sales team is costly, labor intensive and lacks the flexibility to scale rapidly. Lastly, community events can be costly and hard to determine the return on investment (ROI).

A system and method for the automated creation of a virtual lending, borrowing, investing, and saving network, the system and method capable of determining the risk profile and propensity to save associated with each of the potential participants is needed. Furthermore, it would be beneficial to provide a mechanism by which mainstream financial institutions may engage and interact with participants of these virtual networks to directly incorporate mainstream financial services into the network or to otherwise identify millennial, unbanked, underbanked, or new participants that may need external financial services. Furthermore, the ability for these virtual networks to accrue interest on the contributions of network participants provides vast improvement over traditional offline mechanisms. The system and method of the present invention was inspired by traditional ROSCAs and informal social banking traditions, but incorporates non-conventional means for adapting these traditional partnerships into tech-ready, virtual networks that are better regulated, provide greater insight into financial health and risk profiles of participants, mainstream the concept of formal social banking, and serve as a means for providing banks the ability to attract and retain customers within the formal banking system. Furthermore, the system and method of the present invention, in one embodiment, provides a novel approach to social banking and savings processes, further increasing the mainstream abilities of social banking.

### BRIEF SUMMARY OF THE INVENTION

In various embodiments, the present invention is directed to a system and method utilizing artificial intelligence and blockchain technology to automate, maintain, and regulate lending networks, cryptocurrency exchanges, savings accounts, and credit repair intervention mechanisms through a mobile savings platform that is connected to a financial institution and can be used as an instrument for credit repair or to save, borrow, and lend money amongst a network of individuals. The present invention also utilizes blockchain and artificial intelligence to verify and protect data and information shared with participants and financial institutions.

Generally speaking, the mobile savings, lending, and borrowing platform is accessed by a network of individuals (or users), each user associated with an individual social banking account (which may, for example, be identified as a Sou Sou Account, Sou Sou Lending Circle, Sou Sou Coin, or Sou Sou Card associated with the social banking platform offered by Invest Sou Sou) that connects to a mainstream bank account. In one embodiment, each user's financial health is accessed in order to customize an automated savings, investment, or credit building plan based on the user's goals. The user's social banking account can also be used to invest a predetermined amount of money at a specified frequency/period into a savings account, checking account, or lending circle account (which is a collective account associated with multiple participants associated with a single social banking circle). User's may join social banking networks by inviting friends, family, and peers to save or invest with them. Once a user has joined a specific social banking network, that user may be said to be participant in that network, with a network including a number of participants working together to help accomplish one or more goals.

In addition to allowing users to become participants in various networks based on defined goals, the invention also tracks the progress of users in meeting their financial goals and determines a user's financial health using indicators like saving habits, credit score, spending habits, cash flow, participation in social networks, etc. The invention uses virtual and peer-driven perks, nudges, and peer pressure to help participants keep their financial commitments. In one embodiment, artificial intelligence and machine learning is used to track the most effective interventions for a particular user or network, which may be updated overtime to provide the user the types of interventions that are most likely to help that user meet its goals. In this regard, the system may determine that a particular user is more motivated to save when they receive perks, and in turn, may offer perks to that user in order to see that user meet their financial goals. Alternatively, the system may find that another user is more inclined to save based on peer pressure from its network peers, and may seek to have peers provide more encouragement and pressure for that participant. Of course, any number of different interventions (perks, nudges, peer pressure, saving recommendations, credit building interventions, investment guidance, etc.) may be provided to users to help them meet their goals. The social connectivity provided by the system promotes participants keeping to their financial commitments and allows the monitoring of spending habits.

Once a financial goals is reached, the invention provides various options to the participant allowing the particular participant to withdraw or otherwise use funds from the particular social banking network at that particular time. For purposes of describing the invention, a participant who has the ability to use those funds at a particular time may be referred to herein as the “payout participant,” and the withdrawal (cash-out) or other use of the funds (i.e. for a loan, to purchase a perk or reward, or to apply toward an investment) may be collectively referred to herein as a “payout” for the payout participant. In one embodiment, users participate in social savings networks, where participants in the networks can collectively save towards individual or group financial goals. A participant becomes a payout participant when that user's goal is met, and the funds available to the payout participant in a social savings network are the funds that user has saved to that date. In these social savings networks, user's do not contribute to a network account, but instead, a participant in the network saves toward individual goals while other participants monitor the participant's savings progress and encourage them to meet those savings goals.

In an alternative embodiment, the system of the present invention allows users to participate in a lending circle network, where the participant's all contribute to a network account (with each participant's funds managed separately within the network account as to ensure no comingling of individual participant's funds). In this type of network, the payout participant is designated based on a rotation decided by the network participants, with each participant being designated a payout participant at one of a periodic list of decision days (or days where a payout is provided). The funds are accessible by a particular payout participant on his or her decision day include the total contributions made by the payout participant up to that point plus any interest earned by those funds.

Thus, it may be seen that the platform is useful for facilitating savings among the network, allowing the network to set its own savings goal and to earn interest on the total sum of the contributions made to the network by the combined participants. In one embodiment, the platform allows for the network of individuals to propose their own payout terms/interest rates and the amount of installment payment, or alternatively, the platform or partnering financial institution may set rates and rules of the network. Once agreed upon, the platform uses AI and block technology to maintain and regulate the network and allows the network to fund the requested payout to the payout participant. In one embodiment, one or more participants of the social banking network may be matched to mainstream, banking institutions, so the participants will, have access to the banks' products and services using an origination platform that works in connection with the social banking platform (for example, Invest Sou Sou's exclusive origination channel Sou Sou Capital Connector™). In the preferred embodiment, the origination platform (such as Sou Sou Capital Connector) is a cloud based digital platform and mobile application with white-label API capability that uses a matching technology which encompasses artificial intelligence/machine learning, blockchain, and data analytics in order to curate individualized credit risk profiles, financial health scores, and referrals (e.g. leads) for lenders, government insurers, associations, affinity groups, and bonding agents. The Sou Sou Capital Connector platform contains a data driven dashboard and a dynamic deal flow tracker with real time user feedback. Furthermore, Blockchain is used to verify and ensure the data integrity of leads (e.g. prospective loan applicants) to lenders.

Artificial intelligence is incorporated into the platform to collect and analyze data associated with the network in order to produce a risk score and financial health score for network participants, which may be transmitted securely to connected financial institutions, allowing the financial institutions to share more traditional financial products with the network participants. Blockchain is incorporated into the platform as a way to hash data on a blockchain, separate and store that data on separate cloud based services to preserve the integrity of data for each participant and transaction, and verify that data if needed for participants and financial institutions.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a flowchart outlining various steps of one embodiment of the lending circle network function of the present invention.

FIG. 2 is a schematic diagram showing one embodiment of the system of the present invention, particularly showing a number of lending circle networks of individuals connected to network assets maintained at a bank through the managing platform.

FIG. 3 is a schematic diagram showing one embodiment of the system of the present invention, particularly showing a single lending circle network of individuals connected to network assets maintained at a bank through the managing platform.

FIG. 4 is a flowchart outlining various steps of one embodiment of the lending circle network creating process of the method of the present invention.

FIG. 5 is a schematic diagram showing one embodiment of the system of the present invention, particularly showing a participant of a lending circle network contributing an initial deposit to an escrow deposit account and periodic contributions to a cash reserve associated with the network and maintained by a banking partner.

FIG. 6 is a flowchart outlining various steps of one embodiment of the payout process of a lending circle network as provided by the present invention.

FIG. 7 is a schematic diagram showing one embodiment of the system of the present invention, particularly showing one payout option of the payout process of lending circle network the present invention, where the payout participant has selected the cash-out payout option.

FIG. 8 is a schematic diagram showing one embodiment of the system of the present invention, particularly showing one payout option of the payout process of the present invention, where the payout participant has selected one of various financial services (e.g. loan, investment, etc.) payout options.

FIG. 9 is a flow diagram showing various steps one embodiment of the general, overall method of the lending circle network of the present invention.

FIG. 10 is a flow diagram showing various steps of one embodiment of the user enrollment and authentication process of the overall lending circle network function of the present invention.

FIG. 11 is a flow diagram showing various steps of one embodiment of the contribution (pay-in) and payout process of the overall lending circle network function of the present invention.

FIG. 12 is a schematic diagram showing one embodiment of the system of the present invention, particularly showing a participant of a social savings network of the present invention funding saving goals provided in the social savings network account of the participant.

FIG. 13 is a schematic diagram showing one embodiment of the system of the present invention, particularly showing one embodiment of a social savings network of the present invention where participants provide encouragement interventions to the saving participant and where banks provide products and services to the saving participant.

FIG. 14 is a first part of a flow diagram showing various steps of one embodiment of the method for providing a social savings network as described herein.

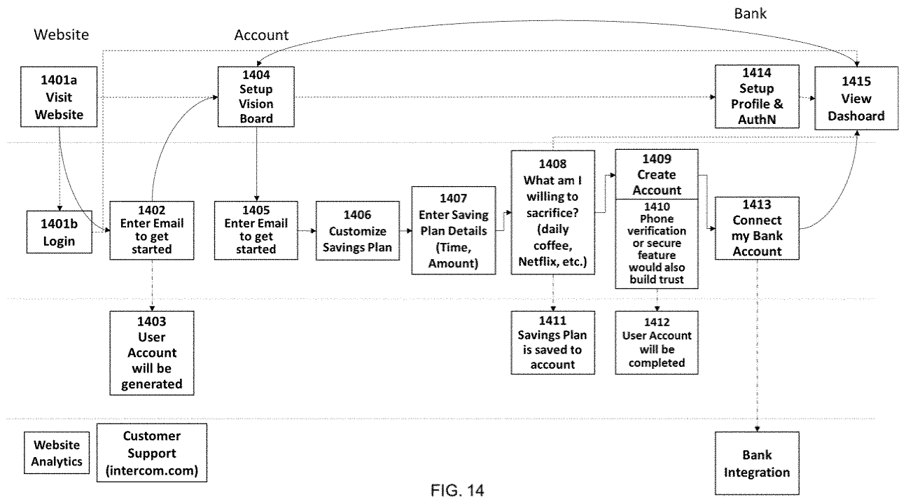

FIG. 15 is a second part of a flow diagram showing various steps of one embodiment of the method for providing a social savings network as described herein.

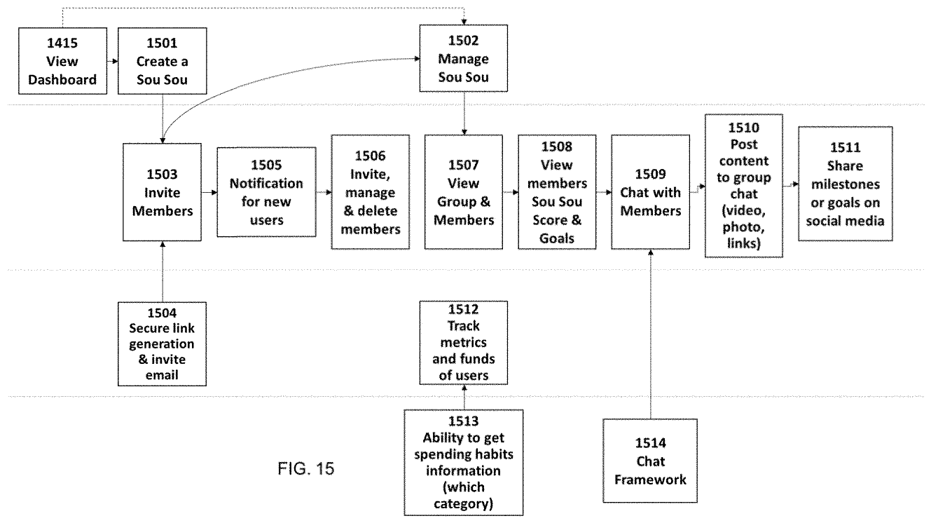

FIG. 16 is a third part of a flow diagram showing various steps of one embodiment of the method for providing a social savings network as described herein.

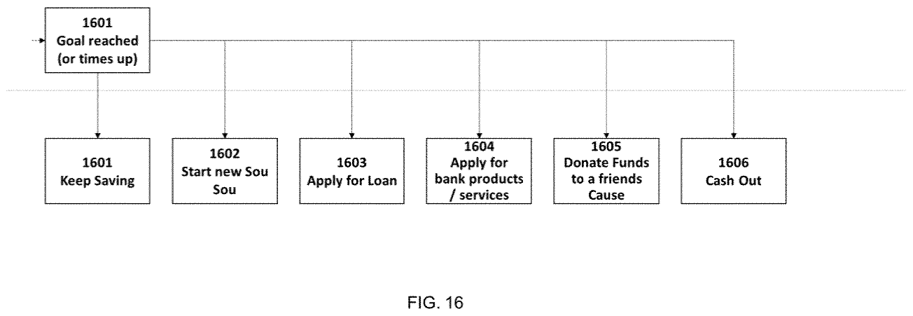

### DETAILED DESCRIPTION OF THE PREFERRED EMBODIMENT(S)

The present invention is directed to a system and method utilizing artificial intelligence to automate social banking accounts (which may, for example, include social saving networks and social lending circles) and credit repair intervention through a mobile savings platform that is connected to a financial institution and can be used as an instrument for credit repair or to save, borrow, invest, and lend money amongst a network of individuals. Where the definition of terms departs from, the commonly used meaning of the term, applicant intends to utilize the definitions provided below, unless specially indicated:

The term “platform” refers to the computerized system executing software for carrying out the system and method described herein. In particular, the platform functions to (a) communicatively connect users, banks, and bank accounts, (b) collect user data, (c) send perks, nudges, notifications, or other interventions to users, and (d) facilitate the savings, lending, investing, and borrowing functions of the system and method of the present invention through social network and network communications. The platform may be embodied by a webpage in a browser, a mobile application on a mobile device, or by any other electronic means accessible by users.

The term “user” refers to an individual who has, either by invitation or through independent means, accessed the platform in order to participate in the services provided and facilitated by the platform. A user may be a person, an association or group of persons, or a business entity. The user may access the platform through a “user device”, such as a mobile phone, computer, or other device.

The term “network” generally refers to a social banking network, or a social banking relationship between many users, where the social banking network has a set of rules and obligations that encourage and facilitate lending, borrowing, investing, and saving by the users through social networking and network communications. In one embodiment, a network may be created by an individual user, known as the “network manager” and may be accessed by users to participate in the lending, borrowing, investing, and savings facilitated by the network. The term “participant” refers to a user associated with a particular network. It may be seen, then, that each network will consist of numerous participants. It may also be seen, then, that the platform will maintain and develop and be used by many users participating in many different networks.

A network may, in one embodiment, be a “social savings network” where participants, through social networking and communications, encourage each other to reach their financial goals (as described more below).

A network, in another embodiment, may be a “lending circle network”, which as described more below, is a network of participants who contribute funds in periodic intervals to a network reserve account (a collective account of all the funds in a network) and where one participant (the payout participant) at each periodic interval has access to at least a portion of the funds in the network reserve account. The term, “contribution” refers to an amount of money or other currency that is contributed to the network reserve account by each of the participants of the network. Contributions are made by each participant on a particular day of the network rotation period (i.e. the periodic timeline at which the rotation of the network occurs, as explained more fully below). The day the participants make a contribution to the network may be referred to herein as a “contribution day.” The contributions made by the participants of a lending circle network may be held in a network's “cash reserve” which is operated and maintained by a banking partner and holds the accessible funds of the lending circle network. The term “deposit” refers to an initial deposit paid by each participant of a network to join the network. The deposit is held in the network's escrow account (maintained by a banking partner) and remains in the escrow account until the end of a full cycle of the network rotation schedule, at which point the deposit may be returned to a participant if the participant has met all obligations of the network.

The term “payout participant” refers to a particular participant of a network who, at a particular time, is the participant of the network selected to access funds. In a lending circle network, for example, the payout participant is determined based on the rotation determined by the network participants and the payout participant, on its assigned day, has access to use at least a portion of the funds from the network's cash reserve by making one of several decisions regarding funds in the account (described more fully below). In a lending circle network, the payout participant changes throughout the rotation cycle of the network such that each participant acts as the payout participant at least once during the network cycle. In a social savings network, on the other hand, the payout participant may be the participant associated with a particular savings goal and may be designed the payout participant when the goal is met. Such payout participant in the social savings circle has access to the funds it has deposited into its social savings account.

The term “user risk score” (which may also be called the “financial health score”) refers to a score calculated by the platform that is associated with each of the registered users of the platform. The user risk score may be based on numerous factors, including a soft credit check of the user, to determine characteristics and conditions associated with the user's ability to become an active participant in an existing network (or to create a new network). More information regarding the calculation and use of the user risk score is provided below.

Having defined some basic terms used in describing the system and method of the present invention, a general description of the system and method may now be provided. Generally speaking, the present invention is directed toward a system and method utilizing artificial intelligence to automate social banking networks and credit repair intervention through a social banking platform. The system and method may be executed via a software application such as a mobile application 4 that provides an alternative financing solution for saving, borrowing, and investing money. The software application or mobile application 4 may be implemented on an electronic device including those configured for mobility and/or portability. Access to the software application or mobile application 4 may be gained through an electronic network which may be installed, for example, on the aforementioned electronic device. The software application or mobile application 4 provides users 2 with the ability to create or join savings and credit repair networks 12 (thereby becoming participants 2 in those networks 12) where participants 2 in the network 12 may save money, loan money, barter expertise and resources, or invest. In some embodiments, the networks 12 are utilized as a tool to build the participants' 2 credits such that participants 2 may be targeted by financial institutions 10 for traditional financial services, such as loans or lines of credit. Artificial intelligence may be used to gather, record, and analyze data associated with non-network users (i.e. users that have not yet joined a network) and participants of networks such that the users and participants, platform developers, and financial institutions may gain insight to the risk characteristics and behavior associated with any given user or participant.

Generally speaking, the system and method of the present invention are executable through an electronic, web-based platform 4 that may be accessed by a user's 2 device (such as a mobile phone, computer, or other device) to create and participate in a virtual peer-to-peer social banking network that is useful for borrowing, investing, saving, and lending money and for building and repairing a participant's credit. The platform 4 may collect and analyzer user 2 data that in turn may be utilized by traditional financial institutions 10 to offer targeted financial services 59 to the user participant 2. The platform 3 is access by the user 2 to create or join a network 12, customize the terms and conditions of the network 12, crowd-source funds 3, and interact and engage with financial institutions 10, which may receive risk-scores or other user 2 characteristics from the platform 4 to determine the most appropriate financial services to offer user participants 2.

In order to participate in a network 12 maintained and accessible by the savings platform 4, each user 2 must create an individual account 401 with the platform 4. This registration process requires a user 2 to interact with the platform 4 through a graphical user interface, through which the user 2 must input identifying information, such as their name, contact information, and other personal information that may be needed to confirm the identity of the user 2. In some embodiments a soft credit check 402 of the user 2 is required for the enrollment process. Once the user's 2 identification has been verified, the user 2 may create or join a network 12, at which time the user 2 becomes a participant in that network 10. Initial creation of a profile or account on the savings platform 4 may be initiated by invitation from an existing participant 2 to join a network 12 on the platform 4, by invitation by a financial institution 10 or platform developer to join or create a network 12 on the platform 4, or by initiating an application request on the platform 4 independently. When receiving an invitation or through independent request to join, the user 2 downloads or otherwise accesses the platform 4 on a user device, upon which the input information is requested. If the user 2 has existing financial accounts (such as savings account, checking account, credit card, etc.) that information may, in some embodiments, be linked to the user's 2 individual account on the platform 4. Once a network 12 is created, users 2 may be invited to join the network 12 by the network manager 403 or automatically through the lending platform 4 or partnering bank 10 or in some embodiments may request to join a network 12 upon approval by the network manager, lending platform 4, or partnering bank 10. Once invited, each of the users 2 must input the identifying information required for enrolling 404 and, in some embodiments, a soft credit check is performed 405. This identifying information 404 and soft credit check 405 may be used to calculate a participant risk score or financial health score 406 (which may be, for example, a Sou Sou Score™ proprietary to Invest Sou Sou™), which is described in more detail below. Once accepted by the network 12, the users become participants 2 in the network 12.

Once a user has joined the platform 4 and created a user account/profile 401, 404, the user 2 may request to create a network 12 (or join an existing network 12). Where a user 2 initiates the creation of a new network 12 this particular user 2 would be described as the network manager of the newly created network 12 (the user 2 would also automatically become a participant 2 in the particular network 12). Alternatively, if a network 12 has already been created, the user 2 may request to join the existing network 12 to become a participant 2 in that existing network 12 (of which a different user 2 would be the network manager). Upon the creation of a network 12, various network parameters and characteristics must be defined 401.

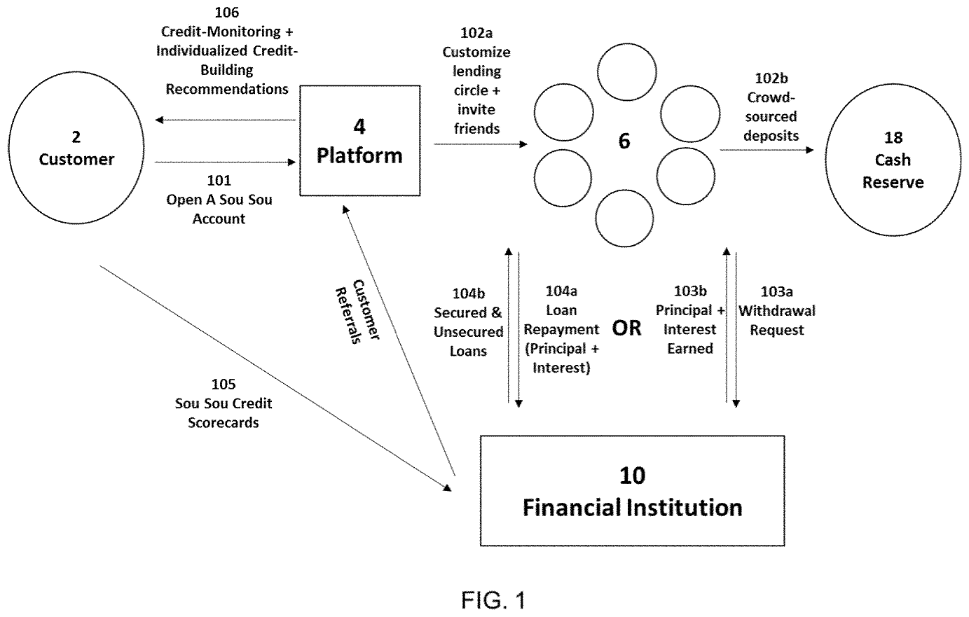

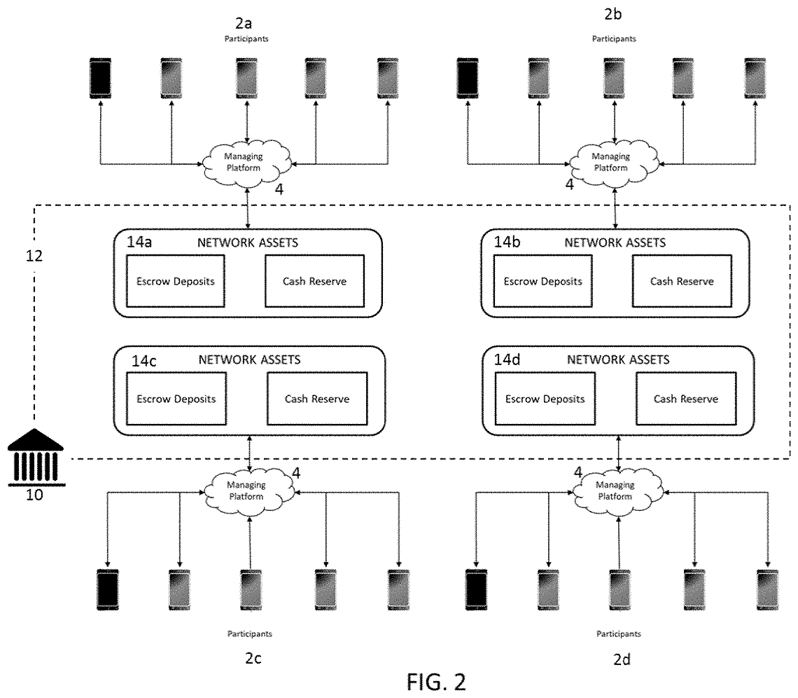

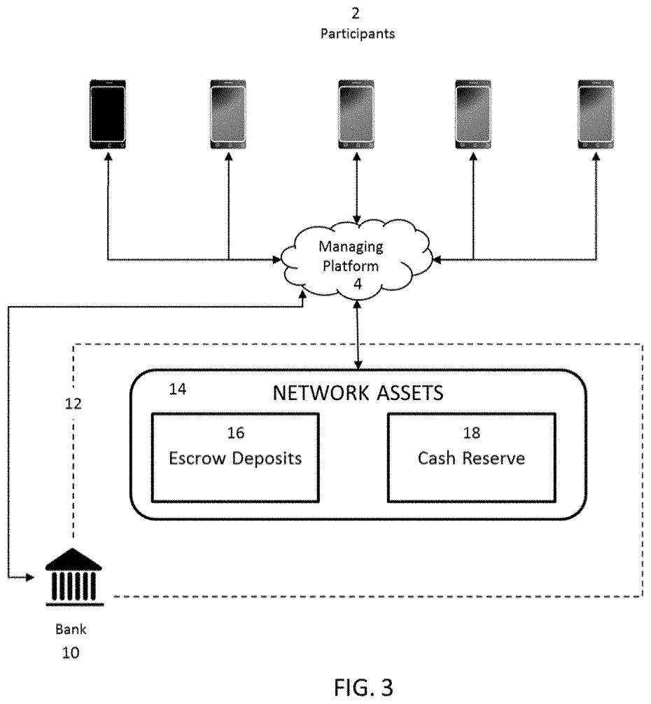

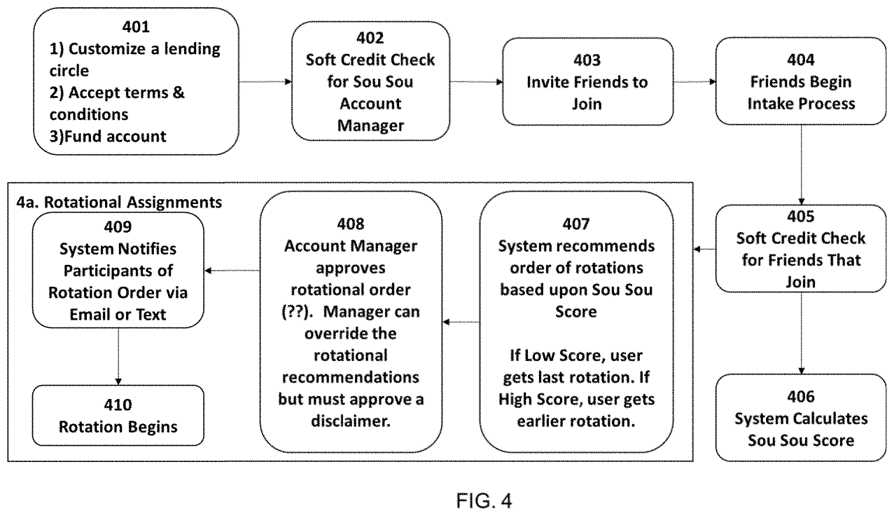

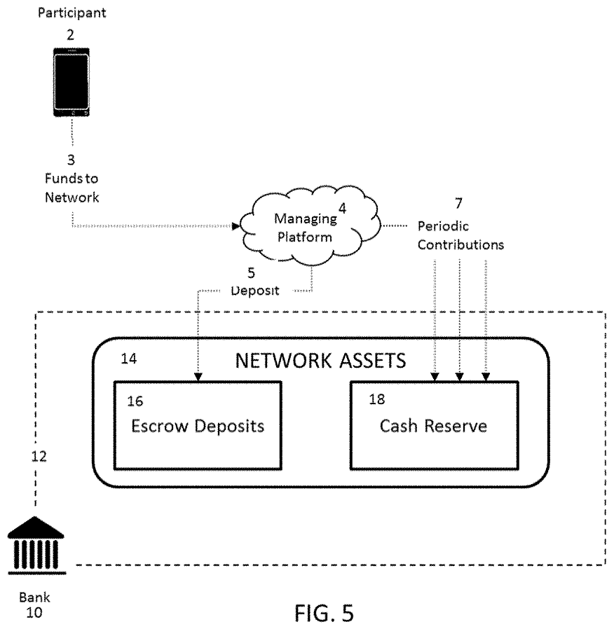

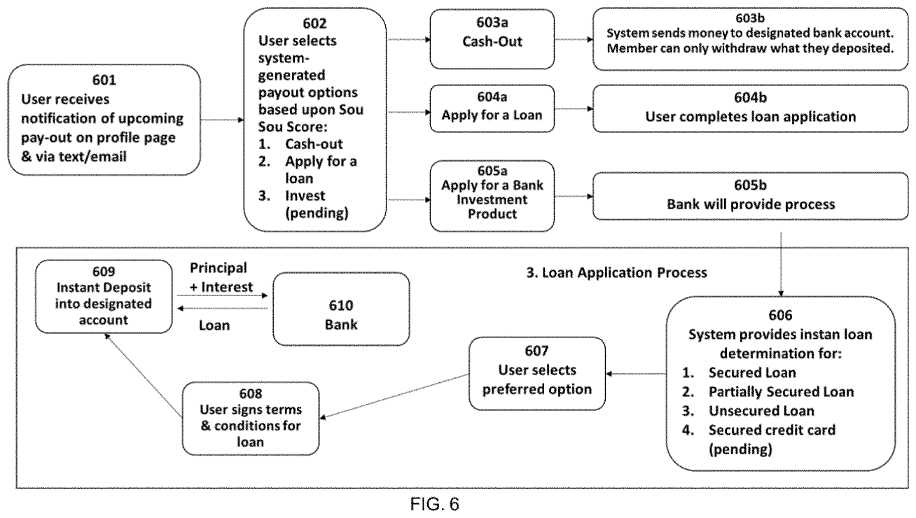

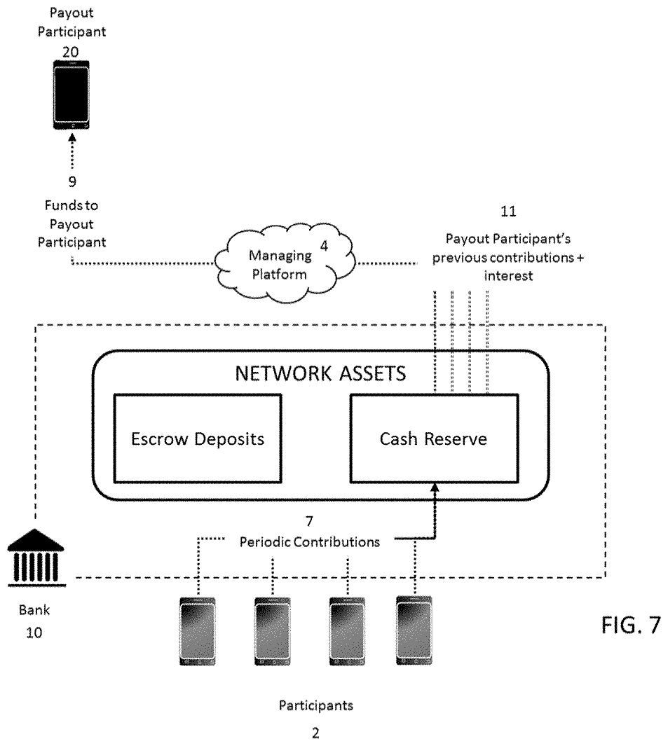

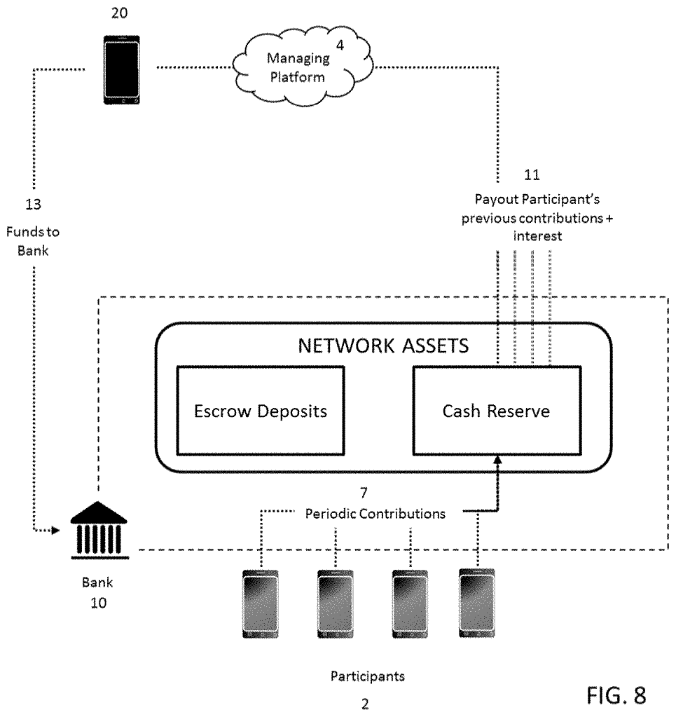

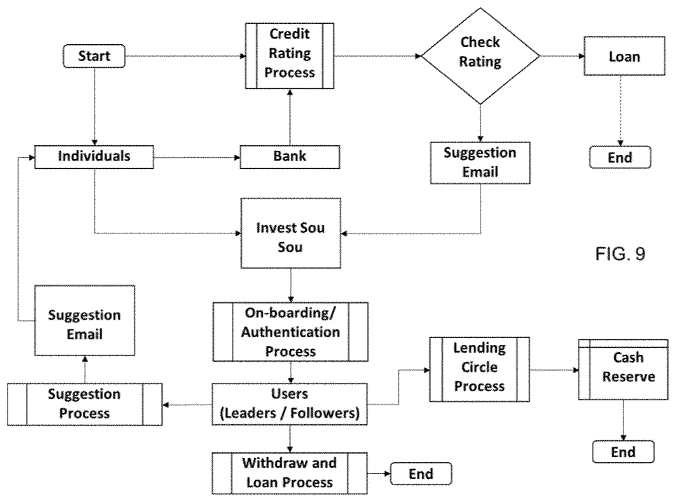

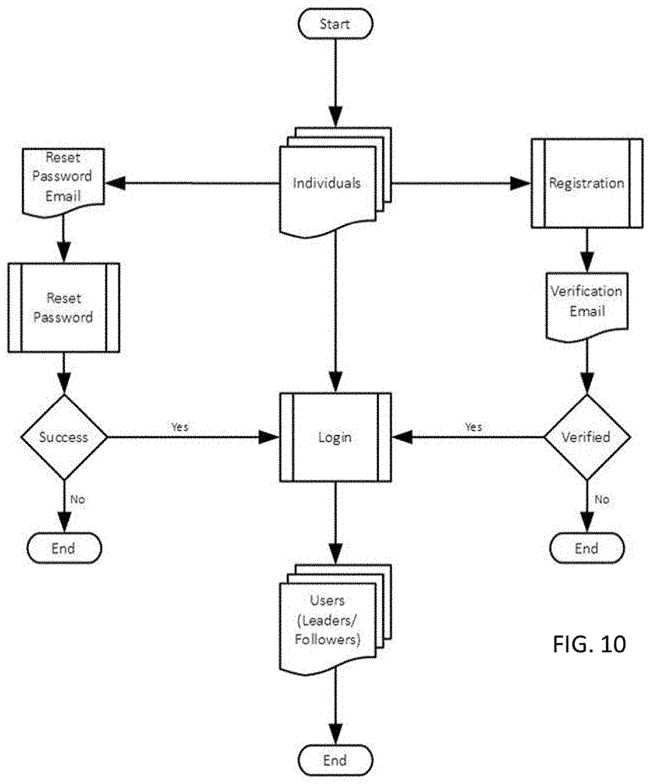

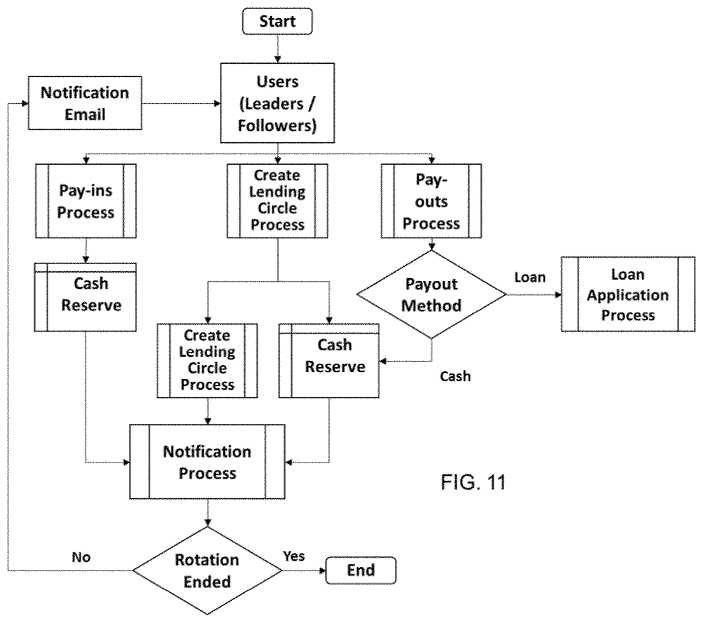

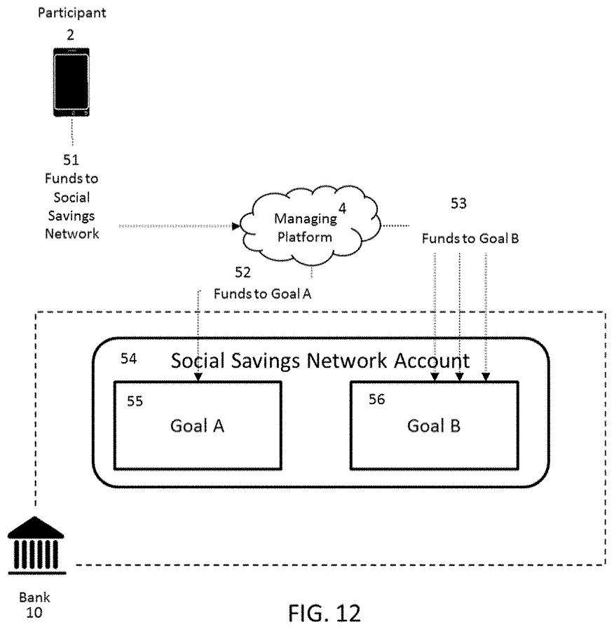

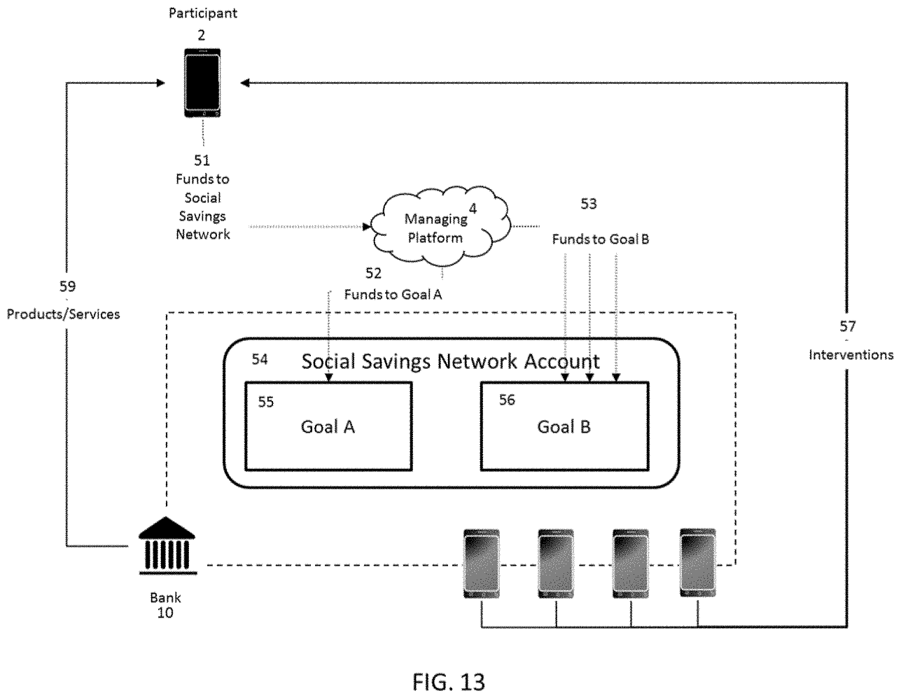

One of the first decisions associated with a particular network 12 is the selection of the type of network 12. As noted above, the system allows for various types of social banking networks 12. In one embodiment, for example, the user 2 may wish to start (or join) a social savings network (as shown in FIGS. 12-13). Alternatively, the user 2 may wish to start (or join) a lending circle network (as shown in FIGS. 1-11). Each type of network 12 uses social banking, social networking, and peer-to-peer communications to help users 2 monitor and encourage each other to meet their financial goals and commitments. Depending on the type of social banking network created, various other parameters may be selected. For lending circle networks, these parameters and characteristics may include: (a) identification of the network manager; (b) benefits for the network manager (for example, perks, commission, revenue-sharing); (c) required characteristics to become a participant and obligations and characteristics for remaining a participant; (d) the required initial deposit amount; (e) the required periodic contribution amount; (f) the time at which each periodic contribution will occur (i.e. the rotation period); (g) the duration of the network (i.e. the network term); (h) the order of rotation for accessing fund reserve (i.e. the rotation schedule); (i) the financial goal of the network; (j) consequences of late payment or other default by a participant; (k) the amount of fees paid to the bank or platform for the services provided in maintaining the network; (l) the identity of the fund-holding bank and other partnering banks; and (m) the amount of interest to be earned on the deposits and contributions. For social savings networks, these parameters may include (a) identification of a savings goal or multiple savings goals, (b) whether your network is visible by friends or others, and (c) who has access to your social savings network.

As participants join a network 12 and the network 12 rules and obligations are established, a network contract is created. This network contract is converted into computer code, stored and can be replicated on the Ethereum, EOS, TRON or similar open-source blockchain based distributed computing platforms and supervised by a network of computers that run blockchain. In one embodiment, the participants 2 involved are anonymous; however, the contract terms will be held on a public ledger shared with the bank 10 and participants 2 on the participant's profile page. The managing platform 4 uses artificial intelligence to analyze data and make recommendations to the bank 10, network managers, and other participants 2.

Lending Circle Networks

Upon the successful invitation to a lending circle network (or upon the successful creation of a lending circle network in the case of the network manager) each participant 2 is required to contribute an initial deposit 5 to an escrow account 16 associated with the network 12. This initial deposit 5 is held in escrow 16 until the completion of the network term (i.e. until the final round of contributions 7 and payout occurs to the final participant 2). Upon the completion of the full network term, these deposits 5 are refunded to each of the participants 2, so long as the participant 2 has met all of his or her obligations during the network term. In one embodiment, the deposits 5 held in escrow 16 will earn interest at a defined rate, which may, for example, later be used to pay fees, dues, or other payments to one or more participants 2, the network manager, the platform 4, or partnering institutions 10. The deposits 5 are preferably held in escrow 16 by a partnering bank 10, with the interest rate to be determined by the bank 10.

After the initial deposit 5 into escrow 16, each of the remaining periodic contributions 7 made by the participants 2 will be placed in a network cash reserve 18, an accessible funds account for periodic access and use by the participants 2 of the network 12. The network's cash reserve 18 is also preferably managed by the partnering bank 10 who manages the escrow account 16. Together, the escrow account 16 and accessible funds 18 account may be referred to as the “network assets” 14. The partnering bank 10 controls the network assets 14 such that the funds held in the cash reserve 18 are accessible by a participant 2 only when the participant 2 becomes the payout participant 20 on the participant's decision day (described in more detail below). When a particular participant's 2 decision day is reached (and thus that participant 2 becomes the payout participant 20), the payout participant 20 may decide how to use or access their portion of the funds 11 held in the cash reserve 18, as described in more detail below. As periodic funds 7 are added into the cash reserve 18 by all of the participants 2, the balance in the cash reserve 18 grows. Because the cash reserve 18 is held and maintained at a bank 10, the cash reserve 18, unlike traditional, offline ROSCA accounts, earns interest based on the amount, of funds in the account 18. It may be seen, then, that because the cash reserve 18 receives contributions 7 from a number of participants 2, the interest earned is far greater than any interest that an individual participant 2 would be able to earn on an individual, private account. In one embodiment, the cash reserve 18 of each of the numerous networks 12 may be combined into a single combined cash reserve 18 for access and use by any of the individual networks 12.

As noted above, once a lending circle network 12 is created and a contract has been formed, the lending network process begins. As noted, first a deposit 5 is secured from each of the participants 2. Following the first deposit 5, on each periodic contribution day (the timing of which is to be set by the rules of the network 407, 408), each participant 2 contributes the agreed upon periodic contribution amount 7 to the cash reserve 18. On each periodic contribution day, one of the participants 2 is selected to be the payout participant 20 for that contribution day. On the payout participant's 20 decision day the payout participant 20 is tasked with determining what action he or she wants to take 602 with regard to the cash reserve 18. One action allows the payout participant 20 to make a withdrawal request 603a from the cash reserve account 18 on his or her decision day. A withdrawal request 603a allows the payout participant 20 to cash-out or deduct funds from the cash reserve 18 into the payout participant's private checking or savings account 603b (it may be contemplated in some embodiments that the cash-out 603a may allow for funds to be withdrawn as cash, through a check or money order, onto a gift card, or any other form of payment to the payout participant 20). A withdrawal request 603a initiates an automatic debit 603b from the network's cash reserve 18 into the cash-out method preferred by the payout participant 20. A withdrawal request 603a or cash-out allows the payout participant 20 to withdraw the portion of the cash reserve 18 equal to the total amount contributed so far by that payout participant 20 plus any interest earned in the cash reserve 18. The remaining funds equal to the contributions T made by other participants 2 (plus interest earned) remains in the cash reserve 18 to continue earning interest at the rate designated. Once funds are withdrawn 603a by a payout participant 20 on the payout participant's decision day, the rotation 410 resumes until the next decision day of a new payout participant 20.

While one option on decision day is for the payout participant 20 to withdraw 603a or cash-out the funds contributed by that participant 20 so far, another option allows the payout participant 20 to apply for a loan 604a. That is, instead of withdrawing 603b funds from the network reserve 18, the payout participant 20 may request a credit-building loan 604a from a banking institution 10 (which may, for example, be the institution holding and maintaining the network assets 14, or may be a different partnering institution) on their decision day. Credit-building loans may be secured loans, partially secured loans, unsecured loans, or may be a secured credit card. In one embodiment, the platform 4 provides an instant loan determination 606 for the loan options and the payout participant 20 selects which option is preferred 607. Once the payout participant 20 signs terms and conditions for the loans 608, the payout participant's 20 funds from the network reserve 18 are deposited into a repayment account associated with the participant and the participant's new loan 609. These funds are used for repayment of the loan to the bank originating and servicing the loan 610.

In addition to the ability to cash-out 603a or apply for a loan 604a, on a payout participant's 20 decision day, the payout participant 20 may also choose an investment option 605a. Like the loan option 604a, the investment option 605a uses the payout funds (the funds of the cash reserve 18 equal to the amount contributed 7 by the payout participant 20 up to that date plus interest) for a financial service provided by the bank 605b rather than transferring the payout funds to the payout participant's personal checking or savings account (or other cash out method).

Social Savings Network

As noted above, one type of social banking network provided by the present invention is a social savings network (FIGS. 12-13). Unlike the lending circle network, where participants 2 make periodic contributions 7 to a joint network reserve 18, participants 2 in a social savings network do not make contributions toward a joint or network account. Instead, a particular participant 24 sets a saving goal 55 (or multiple savings goals 55a, 55b), and allocates money 51 from their own bank account (which is connected to their social banking account 54 associated with the social savings network through the platform 4) toward each of their savings goals 55a, 55b, able to determine how much funds 52, 53 it would like to provide to each goal 55a, 55b. That participant 24 has the ability to invite friends, family, and other peers 26 to join their social savings network in order to allow those friends, family, and peers 26 to help keep the participant 24 on track with their saving goals 55a, 55b. Participants 24, 26 in a social savings network can chat through the platform 4 to provide encouragement to one another. Other interventions 57 to keep the saving participants 24 encouraged to meet their goals 55a, 55b are also available. The system uses artificial intelligence and machine learning to track the saving and spending habits of participants 24 and how those saving and spending habits relate to the participant's 24 progress in meeting its saving goals 55a, 55b. Perks such as offering rewards or incentives to the participants for making certain progress in their savings journey may be used to encourage better saving habits (such perks or other encouragement means may be referred to herein as interventions 57). Likewise, peer participants 26 in a social savings network have the ability to “nudge” and peer pressure each other to make sure they are staying on top of their saving progress. In one embodiment, the system has the ability, through AI and machine learning, to determine which of these means of encouragement are the most effective for a particular participant 24, allowing the system to target specific types of encouragement to specific participants 24 based on those methods that work best for that participant 24. Once a particular participant's 24 savings goal 55 is reached, the system allows the participant 24 to cash out (withdraw the fund) or use the funds for a loan, to purchase a perk or reward, or to apply toward an investment.

To create a social savings network, a user first visits the website 1401a or otherwise accesses the platform 4 and enters certain login 1401b information (such as an email 1402) which will create a user account 1403. Upon creation of the account 1403, the user is prompted to setup a vision board 1404 by providing a goal or multiple goals 1405, customizing a savings plan to meet the saving goal(s) 1406, providing details of a saving plan 1407 (which may include, for example, the time and amount associated with the saving goal), and determines what spending habits the user may be willing to forego to meet the savings goals 1408. All of this information is used to create the user's account 1409. In addition, phone verification or some other secure feature 1410 may also be used to make sure the user is who they say they are. The user will also be prompted to connect a personal bank account 1413, from which funds will be transferred to the user's social banking account in order to save funds toward the saving goal. In one embodiment, a profile can be generated that provides details and information about the user, their saving goals, etc., such that other users who have access to the user's profile can learn more about the user associated with the profile 1412. Once an account is created, the user may be prompted to start a social savings network 1501 (which, may be referred to as a Sou Sou when utilized by the proprietary platform developed by Invest Sou Sou). The user will invite other participants 1503 such as family, friends, coworkers, or other peers, and such invitation may be, for example, through a secure link sent via email 1504. Once new members join the network, the network manager (the user who created the network) will receive notifications 1505. As the network continues, the network manager has the ability to invite, manager, and delete members of the network 1506, and has the ability to manage the network throughout the life of the network 1502. As participants join the network, they can view details about the network and other participants 1507, view risk scores and goals associated with the participants in the network 1508, chat with other participants (for example, to provide encouragement as discussed above) 1509, post content to the network (such as videos, photos, and links) to build social interactions and trust among the network participants 1510, and even share milestones or goals associated with the network on external social media websites 1511. At the same time, the platform tracks metrics and funds of the participants (as discussed above) 1512 to determine the habits of participants in order to offer certain perks, rewards, or other interventions to facilitate better saving habits (as discussed above) 1513. When a goal is reached (or time runs out) 1601, the network managing participant is provided with several payout options, which may, for example, include the option to (a) keep saving 1601, (b) start a new social savings network 1602, (c) apply for a loan 1603, (d) apply for bank products/services 1604, (e) donate funds to a friend 1605, or (f) cash out their funds 1606. These payout options may work substantially the same as the payout options described above with regard to the lending circle networks, except that the funds will not come from a network cash reserve that includes contributions from multiple participants, because the social savings network does not consolidate funds from multiple participants into a single cash reserve.

In light of the decision day options discussed above (for both the lending circle networks and social saving networks), it may be seen that the system and method of the present invention allows participants 2 of a network many options with regard to saving, lending and borrowing, and investing funds through the network capabilities of the platform 4. In addition to these saving, lending and borrowing, and investing options, the system and method of the present invention are also useful for providing other related services. For example, as noted above, the platform 4 collects and analyzes user and participant data, which may, for example, relate to the user/participant's 2 money habits, demographic data, etc. The collection and analyzation of this data allows the platform 4 to identify other financial services or resources 59 that may be targeted to specific users or participants 2 based on the platform's 4 assumptions and understanding of the particular user or participant 2. Artificial intelligence may be utilized by the platform 4 to further develop these assumptions about the users or participants 2 so that more effective targeted services may be provided.

Furthermore, as noted above, the platform's 4 collection of data and information related to each of the users 2 of the platform 4 allows the platform 4 to determine a risk-score associated with each of the users 2. The risk-score of the user 2 may be based on weighted/scaled values of various indicator parameters, some of which may be mandatory indicators and some of which may be voluntary indicators. While the amount and identification of indicator parameters may be modified by the platform 4 developers or banking institutions 10 as desired, it is contemplated that the mandatory indicators may include (a) the payment history of the user/participant 2 on the platform 4; (b) the duration of the user/participant's 2 use of the platform 4 and participation in a network 12 on the platform 4; (c) if the user 2 is a business entity, the length of the entity's time in business; (d) if the user 2 is a business entity, the reputation of the business entity (such as a yelp score or other public review-based metric); (d) if the user 2 is an individual, the annual income of the individual (which, may, for example, be IRS-verified); (e) if the user 2 is a business entity, the cash flow (which, may, for example, be IRS-verified revenue) of the business entity; and (f) the user's 2 accumulated savings history (which, may, for example, be bank-verified). Likewise, it is contemplated that voluntary indicators may include (a) the user's 2 credit score; (b) the amount and identification of user's 2 personal collateral; (c) alternative credit or financial scores and characteristics associated with the user 2 (one such alternative credit score may be, for example, a score generated by Happy Mango, which analyzes a user's 2 spending and saving habits online to generate a score); and (d) if the user 2 is or owns a business, the amount and identification of any business collateral. This information may be pulled from the intake survey or enrollment form associated with a user 2 or may otherwise be generated based off outside sources or known information about the particular user 2. For example, the user's 2 time presence on the platform 4 and participating in a network 12 may be determined by retrieving system generated meta-data for the particular user's 2 account on the platform 4. It is contemplated that each of these categories be scaled or weighted and a weighted risk-score be generated.

The platform-generated risk score may be useful for a number of purposes. For example, in one embodiment, an initial risk score for a new user 2 may be generated 406 based off the enrollment information received by the user 2 and by data and information associated with the user 2 that is received from databases, financial institutions, or other partners having relevant consumer data (such as a credit bureau or other institution). This initial risk score may be used to allow or deny access to a network 12 for the particular user 2 associated with the score. Furthermore, if the user 2 is allowed to become a participant 2 in a network 12, the risk score may be used to determine rules and obligations 407 associated with the participant's 2 use of the network 12. For example, the rotation schedule (i.e. the order identifying the payout participant 20 for each payout period day) may be set based off the risk scores 407 of the participants 2 of the network 12. It is contemplated that although the system will recommend a rotation order based off risk scores 407, in some embodiments the network manager may have the capability to override the recommendation 408 so long as the network manager agrees to the terms and conditions of the platform 4 for disclaiming the recommended order and for accepting the risk of such override of the recommended order. It is also contemplated that the platform 4 generated risk score may be useful for providing context to banking partners 10 for the potential risk associated with approving a participant 2 for a loan, investment service, or other financial service. Because the platform 4 generated risk score is calculated based off a number of dynamic parameters (including, for example, the duration of the participant's 2 involvement in a network 12 and the number of completed and missed payments to the network reserve 18 by the participant 2), it is contemplated that the risk score associated with each user or participant 2 will change over time. The dynamic recalculation of the platform generated risk score allows the participant 2, platform 4, and partnering banks 10 to better monitor the creditworthiness of each participant 2 over time so that targeted financial services 57 may be targeted to specific participants. 2 based on credit improvement and growth.

In one embodiment the system of the present invention may utilize cryptocurrency to allow social banking networks to include participants from different countries or who use different currency. Because participants (particularly in the lending circle networks) contribute funds to a network cash reserve, the use of cryptocurrency (such as, for example, a Sou Sou coin developed by Invest Sou Sou) allows for an easy, efficient contribution of funds in a universal currency.

All terms used herein should be interpreted in the broadest possible manner consistent with the context. When a grouping is used herein, all individual members of the group and all combinations and subcombinations possible of the group are intended to be individually included in the disclosure. All references cited herein are hereby incorporated by reference to the extent that there is no inconsistency with the disclosure of this specification. If a range is expressed herein, such range is intended to encompass and disclose all sub-ranges within that range and all particular points within that range.

The present invention has been described with reference to certain embodiment(s) that are intended to be exemplary only and not limiting to the full scope of the present invention.

1. A system for providing a virtual social banking network, the system comprising:
a. a platform connected to the Internet;
b. a plurality of network participants communicatively connected via the platform;
c. a financial institution communicatively connected to the plurality of network participants via the platform;
d. a network account managed by the financial institution, wherein the network account comprises a plurality of participant accounts and a network escrow account, each of the plurality of participant accounts associated with and accessible by one of the plurality of network participants;
wherein the platform is configured to:
i. prompt the plurality of network participants to join the virtual social banking network;
ii. for each of the plurality of network participants, upon the network participant joining the virtual social banking network, receive from the network participant a deposit amount and place the deposit amount into the network escrow account;
iii. for each of the plurality of network participants, and for each of a series of periodic contribution days, receive from the network participant a periodic contribution amount and place the periodic contribution amount into the participant account associated with the network participant, thereby at each periodic contribution day in the series of periodic contribution days generating a sum total participant contribution amount in the participant account, and further generating a network total periodic contribution amount in the network account, thereby with the network escrow account creating a sum total network amount in the network account;
iv. for each of the series of periodic contribution days, designate one of the plurality of network participants as a payout participant; and
v. for each of the series of periodic contribution days, provide the payout participant one or more payout options for a payout amount, wherein the payout amount comprises the sum total participant contribution amount in the participant account associated with the payout participant.

2. The system of claim 1, wherein the one or more payout options to the payout participant comprises one of (a) a cash-out withdrawal of the payout amount, (b) a loan-request option wherein the payout amount is used for repayment of an issued loan, and (c) an investment option wherein the payout amount is invested.

3. The system of claim 2, further wherein the platform is configured to calculate a risk-score associated with each of the plurality of network participants.

4. The system of claim 3, further wherein the platform is configured to determine the availability of each of the payout options based on the risk-score associated with the payout participant.

5. The system of claim 3, wherein the platform is configured to determine the risk score based one or more of (a) a historical record of the network participant's payment or non-payment of the periodic contribution amounts, (b) a duration of the network participant's participation in the network, (C) if the network participant is a business entity, a length of the participant's time in business, (d) a public reputation of the participant, (e) if the network participant is a business entity, a cash flow record of the participant, (f) a credit score associated with the participant, (g) an available collateral amount associated with the participant, and (h) a financial record associated with the participant.

6. The system of claim 3, further wherein the platform is configured to dynamically recalculate the risk score associated with each participant over time.

7. The system of claim 1, wherein the network account is configured to accrue interest based on the sum total network amount in the network account.

8. The system of claim 7, wherein the payout amount provided to the payout participant further comprises at least a portion of the accrued interest.

9. A method for providing savings, investment, and loan opportunities to participants in a social banking network, the method comprising the steps of:
a. at a platform connected to a plurality of users over the Internet, receiving from at least a portion of the plurality of users a request to join the social banking network;
b. approving at least a portion of the requests to join the social banking network, thereby creating a plurality of network participants;
c. for each of the plurality of network participants who join the social banking network, receive from the network participant a deposit amount and place the deposit amount in an escrow subaccount of an overall network account associated with the social banking network;
d. for each of the plurality of network participants, receive from the network participant at each contribution day in a series of contribution days a periodic contribution amount and place the periodic contribution amount in an individual participant subaccount of the overall network account, wherein the individual participant subaccount is associated with that particular network participant, thereby at each periodic contribution day in the series of periodic contribution days generating a sum total participant contribution amount in the participant subaccount, thereby with the total participant amount in all of the individual participant subaccounts creating a sum total network contribution amount in the overall network account, thereby with the escrow subaccount creating a sum total network amount in the overall network account;
e. at each of the contribution days in the series of contribution days, designate one of the network participants as the payout participant;
vi. on or after each of the contribution days in the series of contribution days, providing the payout participant one or more payout options for a payout amount, wherein the payout amount comprises the sum total participant contribution amount in the participant subaccount associated with the payout participant.

10. The method of claim 9, wherein the one or more payout options provided to the payout participant comprises one of (a) a cash-out withdrawal of the payout amount, (b) a loan-request option wherein the payout amount is used for repayment of an issued loan, and (c) an investment option wherein the payout amount is invested.

11. The method of claim 9, further comprising the step of calculating a risk-score associated with the payout participant prior to providing the one or more payout options.

12. The method of claim 11, wherein the step of providing the one or more payout options comprises determining the availability of each of the payout options based on the risk-score associated with the payout participant

13. The method of claim 10, further comprising the step of accruing interest at the network account based on the sum total network amount in the overall network account.

14. The method of claim 13, wherein the step of providing the payout participant with the one or more payout options comprises incorporating at least a portion of the interest accrued into the payout amount.

15. The method of claim 9, further comprising the steps of, via the platform, (a) collecting data associated with each of the network participants, (b) transmitting the data to one or more service provider partners, and (c) selectively allowing the one or more service providers to provide targeted services to one or more of the network participants.

16. The method of claim 9, wherein the approving the requests to join the social banking network step comprises, for each user associated with each request, verifying the identity of the user.

17. The method of claim 9, further comprising the step of designating at least one of the network participants as the network manager for the social banking network.

18. The method of claim 17, further comprising the step of receiving from the network manager a set of rules associated with the social banking network.

19. The method of claim 18, wherein the set of rules associated with the social banking network comprises at least one of (a) requirements for joining the social banking network, (b) a dollar value associated with the deposit amount received from each of the network participants, (c) a time value associated with the series of contribution days, (d) a dollar value associated with the periodic contribution amount, (e) a duration of the network, (f) an ordered list identifying an order at which the network participants will be designated the payout participant, (g) a financial goal of the network, and (h) consequences for non-payment of a periodic contribution amount by a network participant.
